(19) United States
(12) Patent Application Publication
(10) Pub. No.: US 2018/0037999 A1
(43) Pub. Date: Feb. 8, 2018

(54) METHOD OF PRODUCING CATHODIC CORROSION PROTECTION FOR PROTECTION OF REINFORCING STEEL IN A FERROCONCRETE STRUCTURE

(71) Applicant: KOCH GMBH, Kreutzal (DE)

(72) Inventors: Detlef KOCH, Kreutzal (DE); Majid MAHJOORI, Siegen (DE)

(73) Assignee: KOCH GMBH, Kreutzal (DE)

(21) Appl. No.: 15/553,896

(22) PCT Filed: Feb. 24, 2017
(86) PCT No.: PCT/EP2016/053876

§ 371 Date: Aug. 25, 2017

(30) Foreign Application Priority Data
Feb. 25, 2015 (DE) 10 2015 203 398.8

(51) Int. Cl. C23F 13/06; C23F 13/16; C04B 28/02

(52) U.S. Cl. CPC C23F 13/06; C04B 28/02; C23F 13/16; C04B 2111/265

(57) ABSTRACT

A method for producing cathodic protection for protecting reinforcing steel (2) in a reinforced concrete structure (1) is provided, in which reinforced concrete structures subjected to chloride-induced corrosion can be simply and durably protected against corrosion. Furthermore, the cathodic protection is also intended to be producible particularly quickly both for new buildings as well as when carrying out renovation/retrofitting work. For this purpose, a textile-reinforced concrete (8) is applied to the reinforced concrete, wherein the textile-reinforced concrete (8) comprises a carbon fabric (10) and a mortar, wherein a continuous electrical voltage is applied between a cathode and an anode and wherein the reinforcing steel (2) is used as the cathode and the carbon fabric (10) is used as the anode.

The invention relates to a method for producing cathodic protection for protecting reinforcing steel in a reinforced concrete structure.

Structures made of reinforced concrete are an integral component of the infrastructure in almost every country around the world. In addition to residential buildings and work buildings, many reinforced-concrete structures are built which are driven on, for example multi-storey car parks, garages, motorways, bridges, tunnels, etc. A large number of these structures are used for anywhere between 50 and 100 years (and sometimes for even longer). However, in addition to mechanical stress, de-icing salts in particular adversely affect the reinforced concrete structures. The de-icing salts generally contain chloride. In conjunction with water, this therefore produces solutions which trigger corrosion in the structures. In many structures, substantial and expensive repair works therefore have to be carried out on the reinforcement even after just 20-25 years.

For this purpose, the contaminated covering concrete is usually removed and the reinforcing steel is cleaned and provided with new corrosion protection (e.g. a polymer-based or cement-based corrosion protection). However, the repaired region often only lasts for a few years (due to mechanical, thermal and/or hygric incompatibilities), and therefore additional repair work is required shortly thereafter, particularly when the covering concrete is subjected to a great deal of stress.

Cathodic protection (CP) of structures represents a possibility for suppressing and ideally stopping corrosion.

The formation of corrosion is prevented by applying a small but continuous protective voltage. The state of the building or the reinforced concrete structure can be monitored by means of remote maintenance. Although CP anode systems available on the market can in fact halt corrosion in reinforced concrete structures, crack-bridging ability, abrasion resistance and slip resistance leave a lot to be desired. In order to render the surfaces suitable for being driven on and to prevent further penetration of moisture and chlorides, additional surface-protection systems therefore have to be applied, which have to be renewed in relatively short, recurring cycles (approximately every 10-20 years).

The object of the invention is therefore to provide a method for producing cathodic protection for protecting reinforcing steel in a reinforced concrete structure and in particular a mortar suitable for this purpose, by means of which reinforced concrete structures that are subjected to chloride-induced corrosion, such as garages, multi-storey car parks and bridges, or else other structures adversely affected by sea/salt water such as harbour installations or swimming pools, can be cathodically protected against corrosion. The mortar is intended to be usable both in damaged structures and in new buildings. In addition to its function for cathodic protection, in conjunction with the fabric the mortar is also intended to bridge cracks, to be usable as static reinforcement and to have a high degree of abrasion resistance and adequate slip resistance.

Furthermore, the cathodic protection is intended to be producible particularly rapidly both in new buildings and when carrying out renovation/retrofitting work.

Systems for cathodic protection are known from WO 99/19540 A1, EP 1 318 247 A1 and WO 96/35828 A1, for example.

The object is achieved according to the invention by a textile-reinforced concrete being applied to the reinforced concrete, wherein the textile-reinforced concrete comprises a carbon fabric and a mortar according to either claim 1 or claim 3, wherein a continuous electrical voltage is applied between a cathode and an anode, and wherein the reinforcing steel is used as the cathode and the carbon fabric is used as the anode.

Advantageous embodiments form the subject matter of the dependent claims.

The invention is based on the consideration that, for a mortar layer/concrete layer that is as thin as possible and is applied both as a reprofiling layer and as a surface protection layer, it is desirable for additional top layers and also additional layers that receive the anode of the cathodic protection to be dispensed with. In this case, it has been found that such a compact system can be achieved if the anode is already part of the mortar layer or concrete layer that is applied to the surface of the concrete over the reinforcing steel to be protected. This is possible when a textile-reinforced concrete comprising a carbon fabric is used, wherein in the context of cathodic protection the carbon fabric is used as the anode and the reinforcing steel is used as the cathode.

Another consideration is that cathodic protection can be achieved particularly effectively when the mortar has a sufficiently high degree of conductivity. Such a high degree of conductivity can be achieved, for example, by an appropriate amount of mixing water to dry mortar. However, it has been found that increasing the proportion of mixing water adversely affects the strength and wear resistance of the mortar, which is then unsuitable for static reinforcements and for use as textile-reinforced concrete. Amongst other things, this causes the mortar to require an additional top layer, which has to be removed once again after some time due to high stress. Within the context of the invention, it has been found that adding admixtures containing salts, in particular nitrates, and/or carbon-containing additives, in particular carbon fibres and/or graphite, is also suitable for increasing the conductivity of the mortar without having to increase the proportion of mixing water with respect to other mortars having acceptable strength and abrasion values. It has been found in this case that, despite the general background that salts are generally harmful to the building structure, in an appropriate dosage said salts are particularly advantageous for increasing electrical conductivity within the context of cathodic protection.

On account of economic and environmentally sustainable considerations, in a particularly advantageous embodiment the salts comprise calcium nitrate and/or ammonium nitrate. Furthermore, these nitrates used are particularly compatible with the concrete and steel. Due to the hygroscopic properties of the two nitrates, even with low ambient humidity the mortar can absorb a higher amount of water and can therefore allow for a sufficiently high degree of electrical conductivity.

For optimum electrical conductivity of the mortar at a given water/cement ratio, the dry weight ratio of the cement-quartz sand mixture and the admixture in the dry mortar is in the range of from 0.1% to 5.5%, and, in a particularly preferred embodiment, is in the range of from 0.7% to 2.7%. As a result, a degree of electrical conductivity can be achieved for the mortar, which is optimal for the cathodic protection.

In order to increase the strength and wear resistance of the mortar, in an advantageous embodiment the dry mortar comprises a hard aggregate, preferably silicon carbide. In a preferred embodiment, for optimum strength and wear resistance of the mortar, the dry weight ratio of the cement-quartz sand mixture and the hard aggregate in the dry mortar is in the range of from 1% to 34%, and, in a particularly preferred embodiment, is in the range of from 11% to 20%. A considerably higher ratio would cause an insufficient amount of hardened cement paste being available for incorporating the aggregate.

In a particularly preferred embodiment, a dry mortar which, in conjunction with mixing water, has the above-mentioned properties comprises:

| | Wt. % |
|---|---|
| Cement | 25-40, in particular 28-32 |
| Quartz sand | 30-50, in particular 28-45 |
| Non-quarzitic additives | 1-25, in particular 5-15 |
| Dry matter of superplasticizer | 0.2-4, in particular 0.8-1.5 |
| Defoamer | 0.5-4, in particular 1-2 |
| Salts | 0.1-4, in particular 0.5-2 |
| Air-entraining agent | 0.1-5, in particular 1-3 |
| Retarder | 0.01-2, in particular 0.05-0.2 |
| Hard aggregate | 1-25, in particular 8-15 |

In an advantageous embodiment, the quartz sand has a grain size of from 0.02 to 4 mm, in particular from 0.1 to 1 mm.

By adding salts and/or carbon-containing additives, a degree of conductivity can be achieved for the mortar, which is sufficient for the cathodic protection, even with a normal or rather small proportion of mixing water. The weight ratio between the mixing water and the dry mortar is in the range of from 0.08 to 0.14, and, in a particularly advantageous embodiment, is in the range of from 0.10 to 0.12. Alternatively or in addition, the weight ratio between the mixing water and the cement proportion of the dry mortar is in the range of from 0.28 to 0.4, and, in a particularly preferred embodiment, is in the range of from 0.35 to 0.37.

In order for the carbon fabric to be contacted in a particularly simple and loss-free manner, in a preferred embodiment a titanium wire coated with mixed metal oxide, a titanium strip anode and/or a conductive adhesive are used as the anode connection and the primary anode contact. In particular, the use of a titanium strip anode coated with mixed metal oxide as the primary anode for feeding in is particularly in this case, since a titanium strip anode of this type has thus far only been used as a secondary anode, i.e. as an anode that directly delivers current.

It is desirable for reinforced concrete elements that are designed to be driven on by motor vehicles to be sufficiently wear-resistant and slip-resistant. For this purpose, in a preferred embodiment a hard aggregate is already admixed to the mortar before this is applied to the reinforced concrete and the carbon fabric. In an additional or alternative embodiment, such a hard aggregate can also be spread in the upper layers of the mortar directly after the mortar has been applied.

The advantages achieved by the invention consist in particular in providing a sufficient degree of conductivity for the cathodic protection, even in the event of low ratios of mixing water to dry mortar or to the cement proportion, by adding salts. In an alternative or additional embodiment, this can also be achieved by adding carbon-containing additives. By adding a hard aggregate, the strength and/or wear-resistance can be further increased. This makes it possible to dispense with additional protective layers, and a very thin structure is thereby produced. In addition to saving materials and reducing repair work, this makes it possible to optimise the accessible height of multi-storey car parks such that taller cars (e.g. SUVs, minibuses) can also park in the multi-storey car parks or garages. As a result of saving reaction resins as surface-protection systems and the increased lifecycles, this system also offers considerable ecological advantages.

An embodiment of the invention will be explained in more detail on the basis of the drawings, in which:

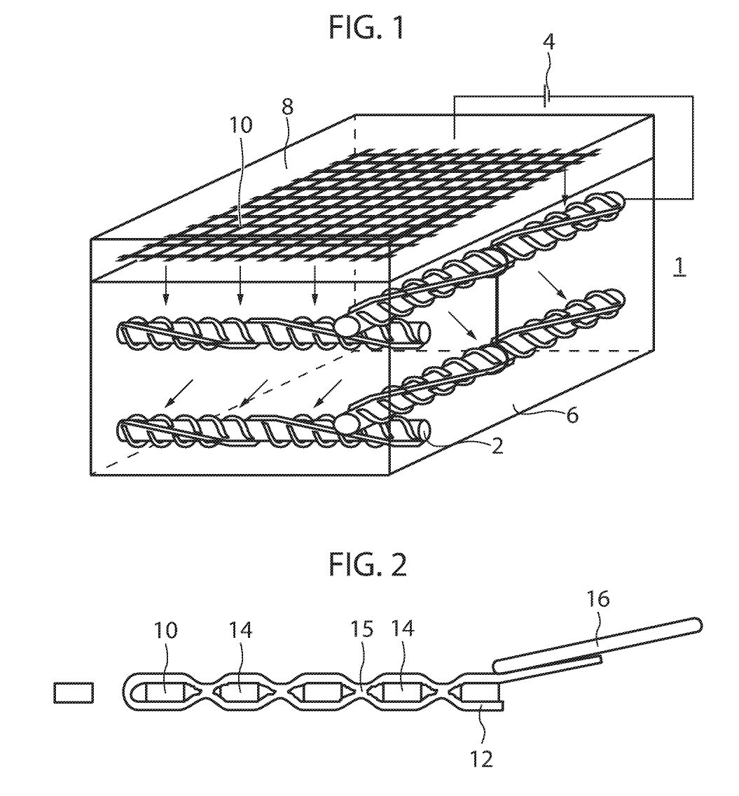

FIG. 1 shows a reinforced concrete structure to which a textile-reinforced concrete is applied in the form of cathodic protection, and

FIG. 2 shows a carbon fabric comprising an anode contact.

Like parts are provided with like reference numerals in all the drawings.

The embodiment according to FIG. 1 shows a reinforced concrete structure 1, the steel reinforcement or the reinforcing steel 2 being protected against corrosion by means of an applied voltage 4. Cathodic protection of this type is required, since, due to various processes such as carbonatation and as a result of the action of chlorides in particular, the passivation of the reinforcing steel 2 may be locally suppressed. As a result, anodic regions that consequently experience metal dissolution, and cathodic regions in which O₂ is formed, are created, altogether leading to the formation of local corrosion sites. For cathodic protection, an electric voltage is applied between the corroding reinforcement and an anode connected to the component.

The primary protective effect is based on the fact that, as a result of the polarisation, the electrochemical reaction equilibriums are shifted to such an extent that the material dissolution in the anodic regions is suppressed in favour of the cathodic partial reaction.

A further primary protective effect is achieved in that the passive regions of the corroding reinforcement are also cathodically polarised, and therefore there is no driving force for the corrosion process. While the primary protective effects take effect very quickly, the secondary protective effects, such as the increase in the OH⁻ concentration at the reinforcement surface or the reduction in oxygen in the vicinity of the reinforcement due to the cathodic reaction and the migration of the negatively charged Cl⁻ ions towards the anode, only become active at a later point and then lead to a reduction in the protective current density.

In the embodiment according to FIG. 1, textile-reinforced concrete 8 comprising a carbon fabric 10 has been applied to the concrete 6 provided, which comprises reinforcing steel 2. In this case, a carbon fabric having a mesh size of from approximately 5-30 mm is preferably used. In this case, the mesh can be square or rectangular. The weight per unit area of a carbon fabric of this type is preferably in the range of from 150-1000 g/m² per layer. Depending on the desired degree of static reinforcement, the system can consist of one or more layers.

The carbon fabric 10 is used as the anode for the cathodic protection in this case. As shown in FIG. 1, the textile-reinforced concrete 8 can be applied to the existing reinforced concrete 6, this method therefore making it possible to retrofit cathodic protection or to extend the cathodic protection in the simplest manner.

In this case, the textile-reinforced concrete 8 is specifically designed not only to provide corrosion protection, but also to reduce cracks or to distribute cracks in conjunction with crack decoupling, to act as a static reinforcement and to be suitable for being directly driven on. This means that further additional protective layers, for example polymer-based layers, are not required. In this case, the textile-reinforced concrete 8 also meets requirements of high pressure resistance for static reinforcement, high abrasion resistance so as to be suitable for being continuously driven on, an increased degree of conductivity compared with previously used types of concrete for optimum cathodic protection, and effective slip prevention for safety when walking and driving. In order to achieve this, the textile-reinforced concrete 8 comprises a mortar having one of the above-mentioned mixture ratios and additives or admixtures. Furthermore, it is also possible to replace a steel reinforcement that is already damaged with textile-reinforced concrete of this type having a carbon fabric, thus eliminating the considerable work effort and high costs (for example due to the omission of exposing the steel reinforcement by means of high-pressure water jets, replacing the reinforcement or the reprofiling process).

Furthermore, the textile-reinforced concrete 8 can provide a high degree of adhesive pull strength for introducing the forces into the substrate, a high degree of bending tensile strength for static reinforcement and crack bridging, a low degree of shrinkage to prevent internal stresses when cured, effective wetting of the fabric 10 for static reinforcement, crack bridging and cathodic protection, and effective processibilty in the form of a self-levelling mortar, for particularly easy application of the mortar in thin layers and for embedding the carbon fabric 10 without it floating to the surface.

As can be seen from FIG. 1, a continuous voltage is applied to the carbon fabric 10 and the reinforcing steel 2 by means of a voltage source 4 in order to ensure the cathodic protection. Due to the use of a close-meshed carbon fabric 10 and the large surface area available as a result, in contrast to otherwise conventional systems for cathodic protection, the voltage can be kept lower. Therefore, up to approximately 10 V, preferably approximately 4-5 V, are usually continuously applied during the entire monitoring process. This voltage can be controlled by a remote-monitoring system (not shown), and therefore the state of the structure or the reinforced concrete construction can be detected and continuously monitored. This makes it possible to control the corrosion by means of the current applied or by means of the voltage in particular. Only when the protective effect is not achieved despite a voltage increase and the voltage limit that would lead to the anode failing is reached do additional measures have to be taken on-site, i.e. directly at the reinforced concrete. In this case, by increasing the anode surface, for example, i.e. in particular by also using a close-meshed carbon fabric 10, the cathodic protection can be improved. It is also conceivable for the air moisture in the region of the reinforced concrete to be increased in order to increase the conductivity of the concrete.

The embodiment according to FIG. 2 shows a possibility for contacting the carbon fabric 10. In this case, a titanium strip anode 12 is laid around a number of carbon fabric fibres 14 and welded in the intermediate spaces of the carbon fabric fibres 14. By welding the titanium strip anode 12, the fabric 10 is firmly pressed against the titanium band 12 so as to ensure effective electrical conductivity. This produces a stable and tight network consisting of the titanium strip anode 12 and the carbon fabric 10, which is only releasable under the application of large tensile forces. In this case, the titanium strip anode 12 is coated with a mixed metal oxide in order to achieve particularly high oxidation resistance. This prevents rapid oxidation in the mortar layer and therefore a loss of electrical conductivity of the titanium strip anode as the feeding-in point.

The end of the titanium strip anode 12 protrudes beyond the carbon fabric 10 and forms a possible connection point for a primary anode wire 16. In the embodiment according to FIG. 2, this primary anode wire 16 is also made of titanium and is welded to the projecting end of the titanium strip anode 12.

The primary anode wire 16 can be connected to the additional copper wire lines in accordance with established standards and specifications. The carbon fabric 10 can therefore be contacted in a particularly simple manner. In an alternative or additional embodiment, a conductive adhesive can also be used to produce electrical contact between the primary anode wire 16 and the carbon fabric 10.

For use within cathodic protection, additional remote-monitoring modules, evaluation units, monitoring units, control units and/or display units are also provided, which can be arranged on-site and/or in the central remote-monitoring system. Additional sensors for measuring corrosion or the state of the reinforced concrete are built in or on the concrete and are connected to the evaluation units, monitoring units, control units and/or display units.

### LIST OF REFERENCE NUMERALS

1 reinforced concrete structure
2 reinforcing steel
4 voltage source
6 concrete
8 textile-reinforced concrete
10 carbon fabric
12 titanium strip anode
14 carbon fabric fibre
16 primary anode wire

1. Method for producing cathodic protection for protecting reinforcing steel (2) in a reinforced concrete structure (1) to which a textile-reinforced concrete (8) is applied, wherein the textile-reinforced concrete (8) comprises a carbon fabric (10) and a mortar, wherein a continuous electrical voltage is applied between a cathode and an anode, and wherein the reinforcing steel (2) is used as the cathode and the carbon fabric (10) is used as the anode, characterised in that the carbon fabric has a mesh size of from 5 to 30 mm and the mortar comprises a dry mortar, comprising a cement proportion, and mixing water, the weight ratio between the mixing water and the dry mortar being in the range of from 0.08 to 0.14 and/or the weight ratio between the mixing water and the cement being in the range of from 0.28 to 0.4, and the dry mortar comprising a cement-quartz sand mixture and an admixture for increasing the electrical conductivity of the mortar, the admixture comprising salts and the dry weight ratio between the cement-quartz sand mixture and the admixture for increasing the electrical conductivity in the dry mortar being in the range of from 0.1% to 5.5%.

2. Method for producing cathodic protection according to claim 1, characterised in that the dry weight ratio between the cement-quartz sand mixture and the admixture for increasing the electrical conductivity in the dry mortar is in the range of from 0.7% to 2.7%.

3. Method for producing cathodic protection for protecting reinforcing steel (2) in a reinforced concrete structure (1) to which a textile-reinforced concrete (8) is applied, wherein the textile-reinforced concrete (8) comprises a carbon fabric (10) and a mortar, wherein a continuous electrical voltage is applied between a cathode and an anode, and wherein the reinforcing steel (2) is used as the cathode and the carbon fabric (10) is used as the anode, characterised in that the carbon fabric has a mesh size of from 5 to 30 mm and the mortar comprises a dry mortar, comprising a cement portion, and mixing water, the weight ratio between the mixing water and the dry mortar being in the range of from 0.08 to 0.14 and/or the weight ratio between the mixing water and the cement being in the range of from 0.28 to 0.4, and the dry mortar comprising a cement-quartz sand mixture and a carbon-containing additive for increasing the electrical conductivity of the mortar, the additive comprising carbon fibres and/or graphite.

4. Method for producing cathodic protection according to any of claims 1 to 3, characterised in that the weight ratio between the mixing water and the dry mortar is in the range of from 0.10 to 0.12 and/or the weight ratio between the mixing water and the cement is in the range of from 0.35 to 0.37.

5. Method for producing cathodic protection according to any of claims 1 to 4, characterised in that the dry mortar comprises a hard aggregate for increasing the strength and/or wear resistance of the mortar, the hard aggregate comprising silicon carbide.

6. Method for producing cathodic protection according to claim 5, characterised in that the dry weight ratio between the cement-quartz sand mixture and the hard aggregate for increasing the strength and/or resistance to wear in the dry mortar is in the range of from 1% to 34%, preferably in the range of from 11% to 20%.

7. Method for producing cathodic protection according to claim 1, characterised in that the dry mortar comprises:
25-40 wt. %, in particular 28-32 wt. % cement,
30-50 wt. %, in particular 38-45 wt. % quartz sand having a grain size of 0.02-4 mm, in particular 0.1-1 mm,
1-25 wt. %, in particular 5-15 wt. % non-quarzitic additives,
0.2-4 wt. %, in particular 0.8-1.5 wt. % dry matter of a superplasticizer,
0.5-4 wt. %, in particular 1-2 wt. % defoamer,
0.1-4 wt. %, in particular 0.5-2 wt. % salts,
0.1-5 wt. %, in particular 1-3 wt. % air-entraining agent,
0.01-2 wt. %, in particular 0.05-0.2 wt. % retarder, and
1-25 wt. %, in particular 8-15 wt. % hard aggregate.

8. Method for producing cathodic protection according to any of claims 1 to 7, characterised in that the carbon fabric (10) is contacted by means of a titanium wire (12) coated with mixed metal oxide and/or a conductive adhesive as the anode connection and the primary anode contact (16).

9. Method for producing cathodic protection according to any of claims 1 to 8, characterised in that a hard aggregate is admixed to the mortar and/or spread in the mortar, the hard aggregate comprising silicon carbide.
